(19) United States
(12) Patent Application Publication
(10) Pub. No.: US 2025/0038528 A1
(43) Pub. Date: Jan. 30, 2025

(54) CONTROL METHOD AND SYSTEM FOR IMPROVING TRANSIENT STABILITY AREA OF GRID-CONNECTED INVERTER

(71) Applicants: HUANGNENG JIANGSU COMPREHENSIVE ENERGY SERVICE CO., LTD., Nanjing City (CN); Tianjin University, Tianjin (CN)

(72) Inventors: Kenan CAO, Nanjing City (CN); Lei CUI, Nanjing City (CN); Jiebei ZHU, Nanjing City (CN); Xuliang JIANG, Nanjing City (CN); Chenhui NIU, Nanjing City (CN); Zhengyang YAO, Nanjing City (CN); Jing ZHU, Nanjing City (CN); Feng LI, Nanjing City (CN); Maoyun LEI, Nanjing City (CN); Minjie HUANG, Nanjing City (CN); Jing WANG, Nanjing City (CN); Mengting JI, Nanjing City (CN); Shaoshuai AN, Nanjing City (CN)

(21) Appl. No.: 18/502,848

(22) Filed: Nov. 6, 2023

(30) Foreign Application Priority Data
Jul. 21, 2023 (CN) 202310900322.0

(51) Int. Cl. H02J 3/00; H02J 3/18

(52) U.S. Cl. CPC H02J 3/00125; H02J 3/0012; H02J 3/1892; H02J 2203/10

(57) ABSTRACT

The invention discloses a control method and system for improving a transient stability area of a grid-connected inverter. It includes performing park coordinate transformation on a three-phase voltage and a three-phase output current of a connection point of a grid-connected inverter to obtain an actual voltage input value and an actual current input value required for current control; obtaining the grid-connected voltage phase through phase-locked loop processing; generating, by the power control module, the current command value required by the current control module; using the sliding mode current control method, by the current control module, to generate a dq voltage signal, and obtaining PWM modulated voltage control signals through inverse park transformation; using a LCL filter to filter out high-order harmonics to achieve grid-connected control. The present invention effectively improves the transient stability of the grid-connected inverter by using the sliding mode control method in the current controller.

### TECHNICAL FIELD

The invention relates to the field of inverter control, in particular to a control method and system for improving a transient stability area of a grid-connected inverter.

### BACKGROUND

In recent years, environmental degradation and energy shortages have become increasingly serious problems, and various renewable energy sources such as solar energy and wind energy have been developed greatly. As a hub connecting new energy sources and the power grid, grid-connected inverters play an increasingly important role in energy conversion.

The nonlinearity imposed applied by the current controller limiter in the grid-connected inverter affects the phase-locked loop dynamics and the transient stability of the grid-connected inverter. The input-output relationship of the inverter is nonlinear. Using a linear controller (PI controller), the dynamic performance deteriorates due to external disturbances, making it difficult to obtain consistent dynamic performance over the entire operating range.

In previous studies, nonlinear tools for transient stability analysis based on Lyapunov's direct method have been widely used, but there are problems with complex calculations and inconsistent calculation processes. Therefore, the existing technology urgently needs a control method to improve the transient stability area of a grid-connected inverter and a unified and simplified Lyapunov function-based method to judge the performance of the improved control method.

### SUMMARY OF INVENTION

The purpose of this section is to outline some aspects of embodiments of the present invention and to briefly introduce some preferred embodiments. Some simplifications or omissions may be made in this section, in the abstract, and in the invention title of the present disclosure to avoid obscuring the purpose of this section, the abstract, and the invention title, and such simplifications or omissions cannot be used to limit the scope of the invention.

In view of the above and/or existing problems in a control method for improving a transient stability area of a grid-connected inverter, the present invention is proposed.

Therefore, the problem to be solved by the present invention is to provide a control method for improving a transient stability area of a grid-connected inverter and a unified and simplified Lyapunov function-based method for judging performance of the improved control method.

In order to solve the above technical problems, the present invention provides the following technical solution: a control method for improving a transient stability area of a grid-connected inverter, which includes obtaining a three-phase voltage of a grid-connected point of a voltage-type grid-connected inverter and a three-phase output current of the inverter; performing park coordinate transformation on the three-phase voltage of the grid-connected point of the grid-connected inverter and the three-phase output current to obtain an actual voltage input value and an actual current input value; performing phase-locked loop processing on the voltage of the grid-connected point of the inverter to obtain a grid-connected phase; generating, by a power control module, a current command value required by a current control module; generating a dq voltage signal by the current control module using a sliding mode current control method, and determining system stability via a system asymptotic stability equation; obtaining a PWM modulated voltage control signal via inverse park transformation, and filtering out high-order harmonics by a LCL filter to achieve grid-connected control; using Lyapunov function based on electromagnetic energy and absorption domain to analyze transient stability of the grid-connected inverter.

As a preferred solution of the control method for improving the transient stability area of the grid-connected inverter according to the present invention, it recites: the park coordinate transformation is to use the park coordinate transformation method to convert the three-phase voltage v_{abc} of the grid-connected point of the inverter and the three-phase output current i_{abc} of the inverter into a three-phase voltage component v_{dq} of the grid connection point of a dq-axis inverter of a two-phase rotating coordinate system and a three-phase output current component i_{dq} of the inverter; the current command value includes that referring to a difference between a reference reactive power Q_{ref} and an actual reactive power Q measured at the grid connection point and a difference between a reference active power Pref and an actual active power P measured at the grid connection point and obtaining reference currents i_{dref} and i_{qref} at a two-phase rotating coordinate system required by the current control module by using the PI controller.

As a preferred solution of the control method for improving the transient stability area of the grid-connected inverter according to the present invention, it recites: the dq voltage signal takes the three-phase voltage component v_{dq} of grid-connected point of the inverter, the three-phase output current component i_{dq} of the inverter, and the reference currents i_{dref} and i_{qref} as inputs to the current control module, so as to output modulation signals v_{di} and v_{qi} in the two-phase rotating coordinate system.

As a preferred solution of the control method for improving the transient stability area of the grid-connected inverter according to the present invention, it recites: the modulated signals v_{di} and v_{qi} in the two-phase rotating coordinate system are expressed as,

$$( \begin{matrix}{v}_{di} \\ {v}_{qi}\end{matrix} ) = ( \begin{matrix}{v}_{d} \\ {v}_{q}\end{matrix} ) - ( \begin{matrix}- {i}_{q} \\ {i}_{d}\end{matrix} ) ω {L}_{f} + {L}_{f} \frac{d}{dt} ( \begin{matrix}{i}_{dref} \\ {i}_{qref}\end{matrix} ) + {L}_{f} λ σ + {L}_{f} ρ tanh ( K σ )$$

$$σ = ( \begin{matrix}{i}_{dref} \\ {i}_{qref}\end{matrix} ) ( \begin{matrix}{i}_{d} \\ {i}_{q}\end{matrix} )$$

$$\frac{d σ}{dt} + λ σ = d ( t ) - ρ tanh ( K σ )$$

where, v_{di} and v_{qi} are the modulation signals in the two-phase rotating coordinate system, v_{d} is the voltage component along the d-axis direction, v_{q} is the voltage component along the q-axis direction, i_{d} is the current component along the d-axis direction, i_{q} is the current component along the q-axis direction, ω is the grid voltage angular frequency, L_{f} is the filter inductance value, i_{dref} and i_{qref} are the reference currents in the two-phase rotating coordinate system; A is the positive gain coefficient of the sliding mode control loop, σ is the switching gain coefficient of the sliding mode control method, p is the proportional gain coefficient of the sliding mode control method, K is the positive real stiffness coefficient gain, tan h(Kσ) is the hyperbolic sine value of the sliding surface multiplied by the gain, and d(t) is the external disturbance.

As a preferred solution of the control method for improving the transient stability area of the grid-connected inverter according to the present invention, it recites: the system asymptotic stability equation is expressed as:

$$λ ( {σ}_{d}^{2} + {σ}_{q}^{2} ) + ρ ( {σ}_{d} tanh ( K σ ) + {σ}_{q} tanh ( K {σ}_{q} ) > ( {σ}_{d} {d}_{d} ( t ) + {σ}_{q} {d}_{q} ( t ) )$$

where, σ_{d}, σ_{q}, d_{d}(t), d_{q}(t) are the components of σ and d(t) in the two-phase rotating coordinate system obtained by using the park transformation, respectively, and tan h(Kσ_{q}) is the hyperbolic sine value of the sliding surface multiplied by the gain; if the system asymptotic stability equation holds true, the system is transiently stable, if the system asymptotic stability equation does not hold, the system is transiently unstable. The grid-connected control includes converting the modulation signals v_{di} and v_{qi} in the two-phase rotating coordinate system into the three-phase PWM modulation signal v_{abci} through using the inverse park coordinate transformation, and passing the three-phase voltage output by the inverter through the LCL filter to filter out high-order harmonics, to achieve grid-connected control of the three-phase voltage type grid-connected inverter.

As a preferred solution of the control method for improving the transient stability area of the grid-connected inverter according to the present invention, it recites: the Lyapunov function based on the electromagnetic energy is expressed as:

$$W ( {t}_{f} ) = \frac{1}{2} {L}_{f} [ ( {i}_{d}^{{f}^{2}} + {i}_{d}^{{f}^{2}} ) - ( {i}_{d}^{{0}^{2}} + {i}_{d}^{{0}^{2}} ) ] + {\int }_{{t}_{0}}^{{t}_{f}} \frac{2}{3} [ P - {P}_{i} ] dt$$

where, Pᵢ is the output power of the grid-connected inverter, W is the electromagnetic energy at time t_{f}, i_{d}^{f} and i_{q}^{f} are respectively the two-phase components of the three-phase output current at fault clearing time t_{f} after performing the park coordinate transformation, i_{d}⁰ and i_{q}⁰ are respectively the two-phase components of the three-phase output current at the fault start time t₀ after performing the park coordinate transformation, and t_{cr} is the key fault clearing time of the system; the Lyapunov function is used to determine the transient stability of the grid-connected inverter based on the conditions of W(t_{f})≤W(t_{cr}).

As a preferred solution of the control method for improving the transient stability area of the grid-connected inverter according to the present invention, it recites: the absorption domain is expressed as:

$$E = {‖ Δ i ‖}^{2} = ( Δ {i}_{d}^{2} + Δ {i}_{q}^{2} )$$

$$Δ {i}_{d} = ( {i}_{d}^{f} - {i}_{d}^{0} ) , Δ {i}_{q} = ( {i}_{q}^{f} - {i}_{q}^{0} )$$

where, Δi is the current vector in the dq coordinate system, Δi_{q} is the difference between the current d-axis component value at the fault clearing time and the current d-axis component value at the fault start time, Δi_{q} is the difference between the current q-axis component value at the fault clearing time and the current q-axis component value at the fault start time; determining the transient stability condition of the grid-connected inverter through the absorption domain is: E(t_{f})≤E(t_{cr}).

Another purpose of the present invention is to provide a system for improving a control method of a transient stability area of a grid-connected inverter, which can improve the transient stability of the grid-connected inverter by constructing a control system.

In order to solve the above technical problems, the present invention provides the following technical solution: a control system for improving a transient stability area of a grid-connected inverter, including a power control module, a current control module and a protection module; the power control module calculates a difference between a reference reactive power Q_{ref} and an actual reactive power Q measured at a grid-connected point, calculates a difference between a reference active power P_{ref} and an actual active power P measured at the grid-connected point, and passes the differences to a PI controller therethrough to obtain reference currents i_{dref} and i_{qref} in a two-phase rotating coordinate system required by the current control module; the current control module uses a sliding mode current control method to generate a dq voltage signal according to a current command value, and obtains a PWM modulated voltage control signal through inverse park transformation to realize grid-connected control of the inverter. The protection module is used to monitor an operating status of the grid-connected inverter and take corresponding protective measures when a fault or abnormal situation occurs, so as to avoid equipment damage or causing instability in the power grid.

A computer device includes a memory and a processor. The memory stores a computer program, characterized in that when the processor executes the computer program, it implements the steps of the control method for improving the transient stability area of the grid-connected inverter as afore-described.

A computer-readable storage medium has a computer program stored thereon, characterized in that when the computer program is executed by a processor, the steps of the steps of the control method for improving the transient stability area of the grid-connected inverter as afore-described are implemented.

Beneficial effects of the present invention: the present invention replaces the traditional PI control of the current controller in the grid-connected inverter with the sliding mode current control, that is, replaces the linear switching control technology with the nonlinear switching control technology, which effectively solves the problem of discontinuous switching state of the inverter and significantly improves the transient stability area margin of the grid-connected inverter; the present invention uses the Lyapunov function based on electromagnetic energy and the absorption domain determination method to determine the transient stability of the grid-connected inverter, which can simplify the calculation complexity of the Lyapunov function and unify the calculation process of the Lyapunov function at the condition with good determination performance.

### BRIEF DESCRIPTION OF DRAWINGS

In order to explain the technical solutions of the embodiments of the present invention more clearly, the drawings needed to be used in the description for the embodiments will be briefly introduced below. Obviously, the drawings in the following description are only for some embodiments of the present invention. For those of ordinary skill in the art, other drawings can be obtained based on these drawings without exerting any creative effort. There are:

FIG. 1 is an overall flowchart of a control method for improving a transient stability area of a grid-connected inverter provided in one embodiment of the present invention.

FIG. 2 is a general control principle block diagram of a control method for improving a transient stability area of a grid-connected inverter provided in a first embodiment of the present invention.

FIG. 3 is a design block diagram of a phase-locked loop of a control method for improving a transient stability area of a grid-connected inverter provided in a first embodiment of the present invention.

FIG. 4 is a park coordinate transformation principle diagram of a control method for improving a transient stability area of a grid-connected inverter provided in a first embodiment of the present invention.

FIG. 5 is a control block diagram of a current control module of a control method for improving a transient stability area of a grid-connected inverter provided in a first embodiment of the present invention.

FIG. 6 is a schematic diagram of a determination method for an absorption domain of a control method for improving a transient stability area of a grid-connected inverter provided in a first embodiment of the present invention.

FIG. 7 is a system structure diagram of a control system for improving a transient stability area of a grid-connected inverter provided in a second embodiment of the present invention.

FIG. 8 a comparison chart of results of a control system for improving a transient stability area of a grid-connected inverter provided in a third embodiment of the present invention.

### DETAILED DESCRIPTION OF THE INVENTION

In order to make the above objects, features and advantages of the present invention more obvious and understandable, the specific embodiments of the present invention will be described in detail below with reference to the accompanying drawings.

Many specific details are set forth in the following description to fully understand the present invention. However, the present invention can also be implemented in other ways different from those described herein. Those skilled in the art can make similar generalizations without violating the significance of the present invention. Therefore, the present invention is not limited by the specific embodiments disclosed below.

Further, “one embodiment” or “an embodiment” as used herein refers to a specific feature, structure, or characteristic that may be included in at least one implementation of the present invention. “In one embodiment” appearing in different places in this specification does not all refer to the same embodiment, nor is it a separate or selective embodiment that is mutually exclusive with other embodiments.

### Embodiment 1

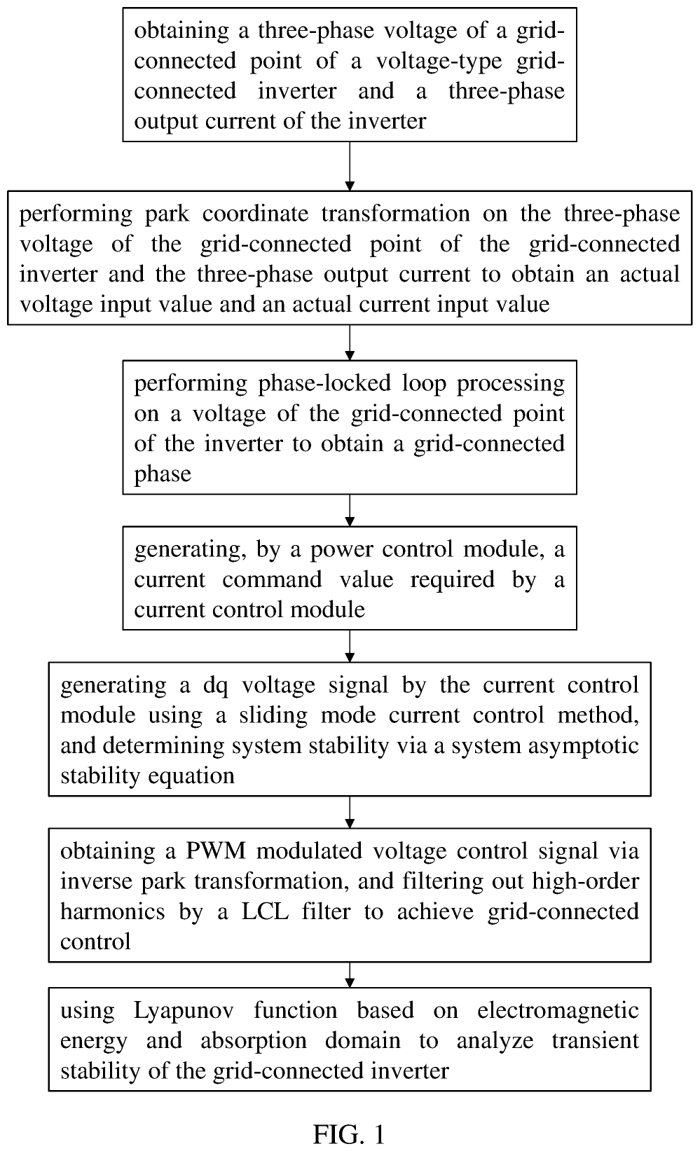

Referring to FIGS. 1-6, a first embodiment of the present invention is shown with providing a control method for improving a transient stability area of a grid-connected inverter, including: obtaining a three-phase voltage of a grid-connected point of a voltage-type grid-connected inverter and a three-phase output current of the inverter; performing park coordinate transformation on the three-phase voltage of the grid-connected point of the grid-connected inverter and the three-phase output current to obtain an actual voltage input value and an actual current input value; performing phase-locked loop processing on the voltage of the grid-connected point of the inverter to obtain a grid-connected phase; generating, by a power control module, a current command value required by a current control module; generating a dq voltage signal by the current control module using a sliding mode current control method, and determining system stability via a system asymptotic stability equation; obtaining a PWM modulated voltage control signal via inverse park transformation, and filtering out high-order harmonics by a LCL filter to achieve grid-connected control; using Lyapunov function based on electromagnetic energy and absorption domain to analyze transient stability of the grid-connected inverter.

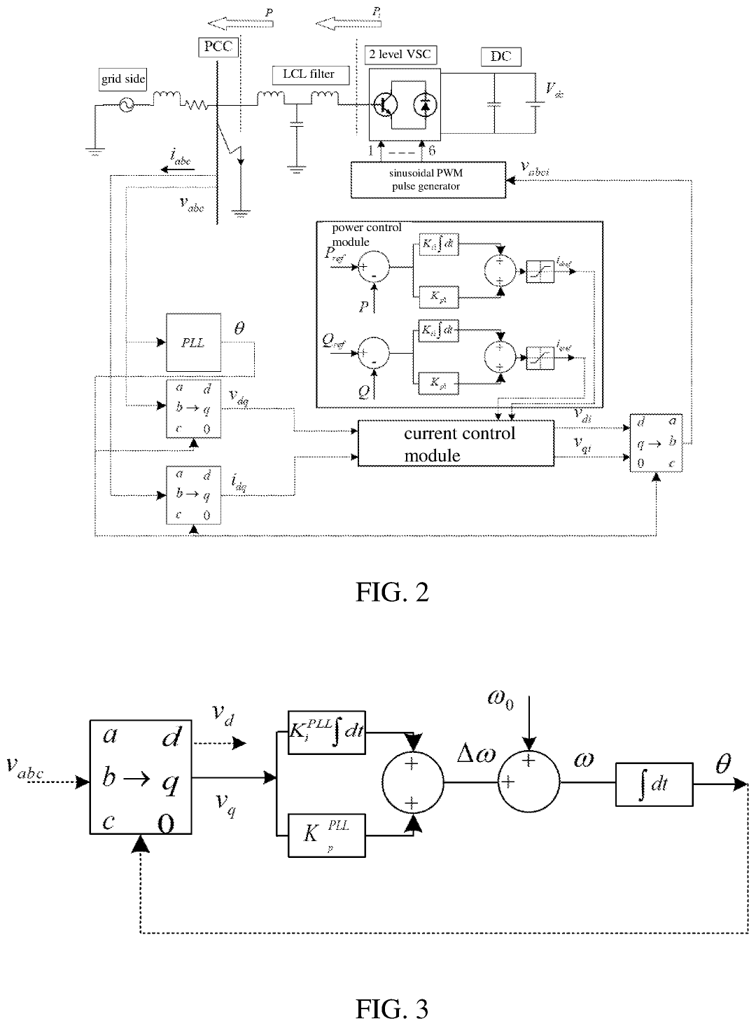

As shown in FIG. 2, the control method for improving the transient stability area of the grid-connected inverter of the present invention involves a three-phase voltage type grid-connected inverter (VSC), which includes: a three-phase inverter bridge unit, in which LCL filter parameters at the VSC output side are C_{f} and L_{f}, an instantaneous value of the three-phase grid-connected point voltage is v_{abc}, an instantaneous value of the grid-connected current on the output side of the inverter is i_{abc}, and an instantaneous value of the DC voltage on the input side of the inverter is v_{dc}.

Park coordinate transformation is performed on the three-phase voltage and the three-phase output current of the grid-connected inverter to obtain an actual voltage input value v_{dq} and tan actual current input value i_{dq} as required for current control.

A grid-connected voltage phase θ is obtained through phase-locked loop processing on v_{abc}; a power control module calculates a difference between a reference reactive power Q_{ref} and Q, calculates a difference between a reference active power P_{ref} and P, and uses the differences to obtain reference currents i_{dref} and i_{qref} at a two-phase rotating coordinate system required by the current control module by using the differences inputted into the PI controller.

The three-phase voltage component v_{dq} of the grid-connected point of the inverter, the three-phase output current component i_{dq} of the inverter, the reference current i_{dref} and i_{qref} are input to the current control module, in which the current control module uses the sliding mode current control method to output modulated signals v_{di} and v_{qi} of a two-phase rotating coordinate system and obtains a PWM modulated voltage control signal v_{abci} vid inverse park transformation.

Finally, the LCL filter is used to filter out high-order harmonics to achieve grid-connected control.

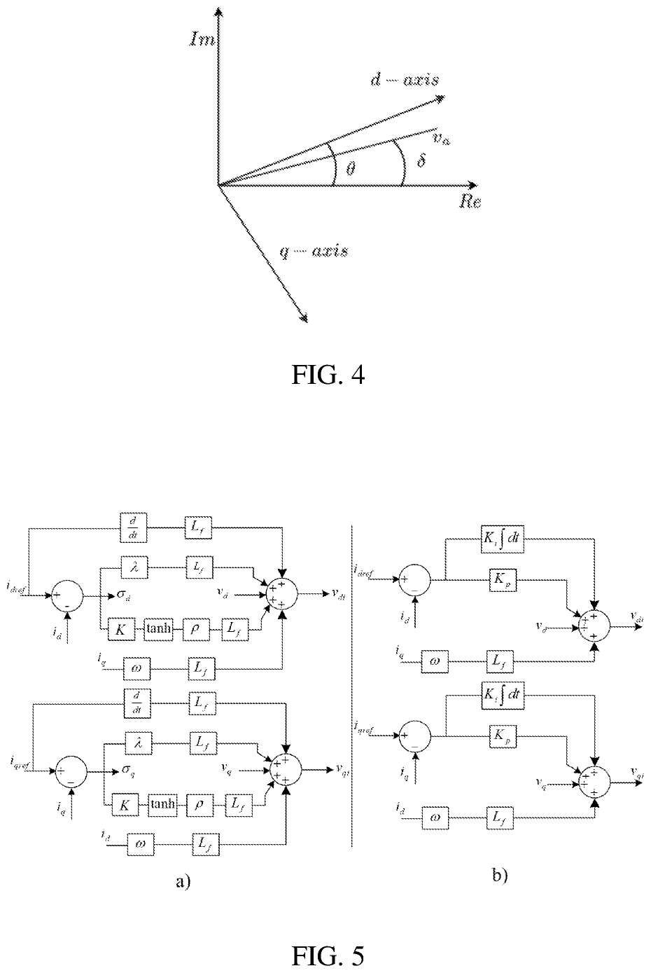

Referring to FIGS. 3 and 4, a module block diagram of a phase-locked loop of a control method for improving a transient stability area of a grid-connected inverter of the present invention is shown. At first, the three-phase voltage v_{abc} is converted into v_{dq} in the two-phase rotating coordinate system through the park coordinate transformation of FIG. 4, and a grid voltage phase θ is obtained through a PI control section.

Referring to FIG. 5, a control block diagram of a current control module of a control method for improving a transient stability area of a grid-connected inverter of the present invention is provided. FIG. 5(a) and FIG. 5(b) are a sliding mode current control block diagram and a traditional PI control block diagram, respectively.

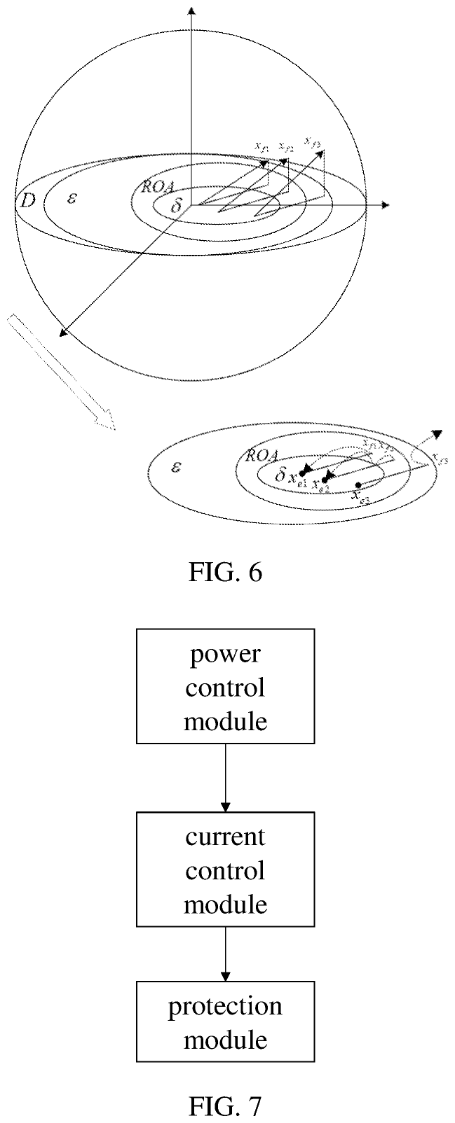

Referring to FIG. 6, it is the absorption domain determination method involved in the present invention. xe1, xe2, and xe3 are three different initial stable states of the system, respectively. When the system is disturbed by the external condition, the state will move within the spherical domain D. When the projection after the moving falls inside the absorption domain (ROA), the system will automatically return to the initial stable state. When the projection after the moving falls outside the absorption domain (ROA), the system will not automatically return to the initial stable state, and then the system will be determined to be transiently unstable at such.

Specific steps are as follows:
obtaining a three-phase voltage v_{abc} of a grid-connected point of a voltage-type grid-connected inverter and a three-phase output current i_{abc} of the inverter;
using a park coordinate transformation method to convert the three-phase voltage v_{abc} of the grid-connected point of the inverter and the three-phase output current i_{abc} of the inverter into a three-phase voltage component v_{dq} of the grid connection point of an inverter in a dq-axis of a two-phase rotating coordinate system and a three-phase output current component i_{dq} of the inverter.
performing phase-locked loop processing on the voltage v_{abc} of the grid-connected point of the inverter to obtain a grid-connected phase θ.

The power control module refers to a difference between a reference reactive power Q_{ref} and an actual reactive power Q measured at the grid connection point and a difference between a reference active power P_{ref} and an actual active power P measured at the grid connection point, to obtain reference currents i_{dref} and i_{qref} at a two-phase rotating coordinate system required by the current control module by inputting the differences into the PI controller.

The three-phase voltage component v_{dq} of grid-connected point of the inverter, the three-phase output current component i_{dq} of the inverter, and the reference currents i_{dref} and i_{qref} are taken as inputs to the current control module, in which the power control module uses a sliding mode current control method to output modulation signals v_{di} and v_{qi} in the two-phase rotating coordinate system and determines system stability via a system asymptotic stability equation.

The modulated signals v_{di} and v_{qi} in the two-phase rotating coordinate system are transformed into the three-phase PWM modulated signal v_{abci} through the inverse park coordinate transformation, and, finally, the three-phase voltage output by the inverter is passed through the LCL filter to filter out high-order harmonics, thereby achieving grid-connected control of the three-phase voltage type grid-connected inverter.

Finally, Lyapunov function based on electromagnetic energy and absorption domain are applied to analyzing transient stability of the grid-connected inverter.

The modulated signals v_{di} and v_{qi} in the two-phase rotating coordinate system are expressed as:

$$( \begin{matrix}{v}_{di} \\ {v}_{qi}\end{matrix} ) = ( \begin{matrix}{v}_{d} \\ {v}_{q}\end{matrix} ) - ( \begin{matrix}- {i}_{q} \\ {i}_{d}\end{matrix} ) ω {L}_{f} + {L}_{f} \frac{d}{dt} ( \begin{matrix}{i}_{dref} \\ {i}_{qref}\end{matrix} ) + {L}_{f} λ σ + {L}_{f} ρ tan h ( K σ )$$

where,

$$σ = ( \begin{matrix}d r e f \\ {i}_{qref}\end{matrix} ) - ( \begin{matrix}{i}_{d} \\ {i}_{q}\end{matrix} ) ,$$

L_{f} is the filter inductance value, K is constant, ω is the grid voltage angular frequency, and p is obtained by:

$$\frac{d σ}{dt} + λ σ = d ( t ) - ρ tan h ( K σ )$$

where, v_{di} and v_{qi} are the modulation signals in the two-phase rotating coordinate system, v_{d} is the voltage component along the d-axis direction, v_{q} is the voltage component along the q-axis direction, i_{d} is the current component along the d-axis direction, i_{q} is the current component along the q-axis direction, ω is the grid voltage angular frequency, L_{f} is the filter inductance value, i_{dref} and i_{qref} are the reference currents in the two-phase rotating coordinate system; λ is the positive gain coefficient of the sliding mode control loop, σ is the switching gain coefficient of the sliding mode control method, p is the proportional gain coefficient of the sliding mode control method, K is the positive real stiffness coefficient gain, tan h(Kσ) is the hyperbolic sine value of the sliding surface multiplied by the gain, and d(t) is the external disturbance.

The system asymptotic stability equation is expressed as:

$$λ ( {σ}_{d}^{2} + {σ}_{q}^{2} ) + ρ ( {σ}_{d} tan h ( K σ ) + {σ}_{q} tan h ( K {σ}_{q} ) > ( {σ}_{d} {d}_{d} ( t ) + {σ}_{q} {d}_{q} ( t ) )$$

where, σ_{d}, σ_{q}, d_{d}(t), d_{q}(t) are the components of σ and d(t) in the two-phase rotating coordinate system obtained by using the park transformation, respectively, and tan h(Kσ_{q}) is the hyperbolic sine value of the sliding surface multiplied by the gain. When this inequality holds true, the system is transiently stable; otherwise, the system is transiently unstable.

The Lyapunov function based on the electromagnetic energy is expressed as:

$$W ( {t}_{f} ) = \frac{1}{2} {L}_{f} [ ( {i}_{d}^{{f}^{2}} + {i}_{d}^{{f}^{2}} ) - ( {i}_{d}^{{0}^{2}} + {i}_{d}^{{0}^{2}} ) ] + {\int }_{{t}_{0}}^{{t}_{f}} \frac{2}{3} [ P - {P}_{i} ] dt$$

where, Pᵢ is the output power of the grid-connected inverter, W is the electromagnetic energy at time t_{f}, i_{d}^{f}, i_{q}^{f}, i_{d}⁰, i_{q}⁰ are respectively the two-phase components of the three-phase output current at fault clearing time t_{f} after performing the park coordinate transformation and are respectively the two-phase components of the three-phase output current at the fault start time t₀ after performing the park coordinate transformation, and t_{cr} is the key fault clearing time of the system;

The Lyapunov function is used to determine the transient stability of the grid-connected inverter based on the conditions of W(t_{f})≤W(t_{cr}).

The absorption domain is expressed as:

$$E = {‖ Δ i ‖}^{2} = ( Δ {i}_{d}^{2} + Δ {i}_{q}^{2} )$$

where E is the absorption domain,

$$Δ {i}_{d} = ( {i}_{d}^{f} - {i}_{d}^{0} ) , Δ {i}_{q} = ( {i}_{q}^{f} - {i}_{q}^{0} )$$

Determining the transient stability condition of the grid-connected inverter through the absorption domain is: E(t_{f})≤E(t_{cr}).

### Embodiment 2

Referring to FIG. 7, which is a second embodiment of the present invention, what is different from the previous embodiment is that a system for improving a transient stability area of a grid-connected inverter is provided, including: a power control module, a current control module, and a protection module.

The power control module refers to a difference between a reference reactive power Q_{ref} and an actual reactive power Q measured at the grid connection point and a difference between a reference active power P_{ref} and an actual active power P measured at the grid connection point, to obtain reference currents i_{dref} and i_{qref} at a two-phase rotating coordinate system required by the current control module by inputting the differences into the PI controller.

The current control module uses a sliding mode current control method to generate a dq voltage signal according to a current command value, and obtains a PWM modulated voltage control signal through inverse park transformation to realize grid-connected control of the inverter.

The protection module is used to monitor an operating status of the grid-connected inverter and take corresponding protective measures when a fault or abnormal situation occurs, so as to avoid equipment damage or causing instability in the power grid.

If the functions are implemented in the form of software functional units and sold or used as independent products, they can be stored in a computer-readable storage medium. Based on this understanding, the technical solution of the present invention essentially or the part that contributes to the existing technology or the part of the technical solution can be embodied in the form of a software product. The computer software product is stored in a storage medium, including several instructions configured to cause a computer device (which may be a personal computer, a server, or a network device, etc.) to execute all or part of the steps of the methods described in various embodiments of the present invention. The aforementioned storage media include: USB flash drive, mobile hard disk, ROM (Read-Only Memory), RAM (Random Access Memory), magnetic disk, or optical disk, which serves as media that can store program code.

The logic and/or steps represented in the flowcharts or otherwise described herein, for example, may be considered a sequenced list of executable instructions for implementing the logical functions, and may be embodied in any computer-readable medium for individually using with or in combination with instruction execution systems, devices or apparatuses (such as computer-based systems, systems including processors or other systems that can fetch instructions from and execute instructions from an instruction execution system, device or apparatus). For the purposes of the present specification, a “computer-readable medium” may be any device that can contain, store, communicate, propagate, or transport a program for use by or in connection with an instruction execution system, apparatus, or device.

More specific examples (non-exhaustive list) of computer readable media include elements as follows: electrical connections with one or more wires (electronic device), portable computer disk cartridges (magnetic device), random access memory (RAM), Read-only memory (ROM), erasable and programmable read-only memory (EPROM or flash memory), fiber optic devices, and portable compact disc read-only memory (CDROM). Furthermore, the computer-readable medium may even be paper or other suitable medium on which the program may be printed. The program may be obtained electronically, for example by optical scanning of paper or other media followed by editing, interpretation or other suitable processing if necessary, and then stored in a computer memory.

It should be understood that various parts of the present invention may be implemented in hardware, software, firmware, or a combination thereof. In the above embodiments, multiple steps or methods may be implemented using software or firmware stored in a memory and executed by a suitable instruction execution system. For example, if it is implemented in hardware, as in another embodiment, it can be implemented by any one or a combination of the following technologies known in the art: discrete logic circuits with logic gates for implementing logical functions on data signals, application specific integrated circuits with suitable combinational logic gates, programmable gate arrays (PGA), field programmable gate arrays (FPGA), etc.

### Embodiment 3

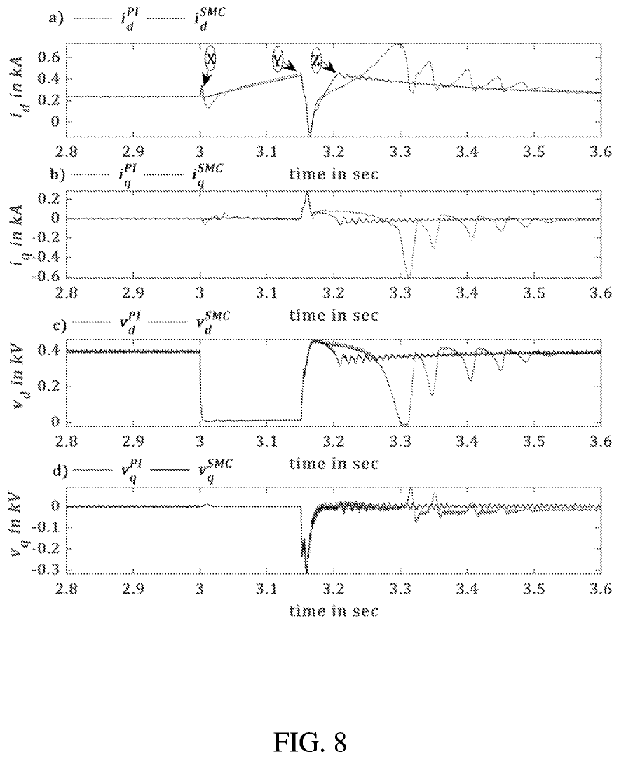

Referring to FIG. 8, a third embodiment of the present invention is provided. The difference between the third embodiment and the first two embodiments is that the technical effects used in the present invention are verified and explained to verify the real effects of the method.

The nonlinearity imposed applied by the current controller limiter in the grid-connected inverter affects the phase-locked loop dynamics and the transient stability of the grid-connected inverter. The input-output relationship of the inverter is nonlinear. Using a linear controller (PI controller), the dynamic performance deteriorates due to external disturbances, making it difficult to obtain consistent dynamic performance over the entire operating range.

The present invention replaces the traditional PI control of the current controller in the grid-connected inverter with the sliding mode current control, that is, replaces the linear switching control technology with the nonlinear switching control technology, which effectively solves the problem of discontinuous switching state of the inverter and significantly improves the transient stability area margin of the grid-connected inverter; the present invention uses the Lyapunov function based on electromagnetic energy and the absorption domain determination method to determine the transient stability of the grid-connected inverter, which can simplify the calculation complexity of the Lyapunov function and unify the calculation process of the Lyapunov function at the condition with good determination performance.

As shown in Table 1, the simulation parameters compare the effects of the improved control method according to the embodiment of the present invention and the traditional PI control method.

TABLE 1
Simulation parameters of our invented control method
and traditional PI control method

| | | | |
|---|---|---|---|
| Parameter | Statement | Unit | Value |

Grid side parameters

| | | | |
|---|---|---|---|
| V_{g} | Grid voltage | kV | 0.48 |
| ƒ_{g} | Grid frequency | Hz | 60 |
| Z_{g} | Grid side impedance | Ω | 0.5 [symbol] 80° |
| SCR | Grid side short circuit | | 2.4 |
| | ratio | | |

Inverter parameters

| | | | |
|---|---|---|---|
| S | Inverter capacity | MVA | 0.2 |
| V_{dc} | DC bus voltage | kV | 0.85 |
| ƒ_{sw} | Inverter switching | kHz | 3.6 |
| | frequency | | |
| L_{f} | Filter inductor | μH | 1700 |
| C_{f} | Filter capacitor | μF | 100 |

Power control module parameters

| | | |
|---|---|---|
| Kₚ₁ | Proportional gain | 0.3 |
| Kᵢ₁ | Integral gain | 10 |

Phase locked loop parameters

| Kₚ^{PLL} | Proportional gain | 950 |
|---|---|---|
| p | | |
| Kᵢ^{PLL} | Integral gain | 1950 |
| Current control module parameters | | |
| (traditional PI control method) | | |
| Kₚ | Proportional gain | 0.5 |
| Kᵢ | Integral gain | 20 |
| Current Control Module Parameters | | |
| (Sliding Mode Current Control Method (SMC)) | | |
| ρ | SMC Proportional gain | 1000 |
| σ | SMC Integral gain | 10 |

As shown in FIG. 8, the effect comparison between the improved control method according to one embodiment of the present invention and the traditional PI control method is provided. Analysis to FIG. 8 shows that using the improved control method proposed by the present invention can effectively slow down the violent fluctuations of current and voltage after a fault occurs. Therefore, using the improved control method of the present invention can effectively improve the transient stability of the grid-connected inverter.

It should be noted that the above embodiments are provided for the purpose of illustrating the technical solution of the present invention and should not be considered as limiting. Although reference has been made to preferred embodiments for a detailed description of the present invention, those skilled in the art should understand that modifications or equivalent replacements can be made to the technical solution of the present invention without departing from the spirit and scope of the invention, all of which are encompassed within the scope of the claims of the present invention.

What is claimed is:

1. A control method for improving a transient stability area of a grid-connected inverter, comprising:
obtaining a three-phase voltage of a grid-connected point of a voltage-type grid-connected inverter and a three-phase output current of the inverter;
performing park coordinate transformation on the three-phase voltage of the grid-connected point of the grid-connected inverter and the three-phase output current to obtain an actual voltage input value and an actual current input value;
performing phase-locked loop processing on a voltage of the grid-connected point of the inverter to obtain a grid-connected phase;
generating, by a power control module, a current command value required by a current control module;
generating a dq voltage signal by the current control module using a sliding mode current control method, and determining system stability vid a system asymptotic stability equation;
obtaining a PWM modulated voltage control signal vid inverse park transformation, and filtering out high-order harmonics by a LCL filter to achieve grid-connected control;
using Lyapunov function based on electromagnetic energy and absorption domain to analyze transient stability of the grid-connected inverter.

2. The control method for improving the transient stability area of the grid-connected inverter according to claim 1, wherein the park coordinate transformation is to use a park coordinate transformation method to convert the three-phase voltage v_{abc} of the grid-connected point of the inverter and the three-phase output current i_{abc} of the inverter into a three-phase voltage component v_{dq} of the grid connection point of the inverter of a dq-axis of a two-phase rotating coordinate system and a three-phase output current component i_{dq} of the inverter;
wherein the current command value comprises that referring to a difference between a reference reactive power Q_{ref} and an actual reactive power Q measured at the grid connection point and a difference between a reference active power P_{ref} and an actual active power P measured at the grid connection point and obtaining reference currents i_{dref} and i_{qref} at a two-phase rotating coordinate system required by the current control module by using a PI controller.

3. The control method for improving the transient stability area of the grid-connected inverter according to claim 2, wherein the dq voltage signal takes the three-phase voltage component v_{dq} of the grid-connected point of the inverter, the three-phase output current component i_{dq} of the inverter, and the reference currents i_{dref} and i_{qref} as inputs to the current control module, so as to output modulation signals v_{di} and v_{qi} in the two-phase rotating coordinate system.

4. The control method for improving the transient stability area of the grid-connected inverter according to claim 3, wherein the modulated signals v_{di} and v_{qi} in the two-phase rotating coordinate system are expressed as:
$$( \begin{matrix}{v}_{di} \\ {v}_{qi}\end{matrix} ) = ( \begin{matrix}{v}_{d} \\ {v}_{q}\end{matrix} ) - ( \begin{matrix}- {i}_{q} \\ {i}_{d}\end{matrix} ) ω {L}_{f} + {L}_{f} \frac{d}{dt} ( \begin{matrix}{i}_{dref} \\ {i}_{qref}\end{matrix} ) + {L}_{f} λ σ + {L}_{f} ρ tan h ( Kσ )$$
$$σ = ( \begin{matrix}{i}_{dref} \\ {i}_{qref}\end{matrix} ) - ( \begin{matrix}{i}_{d} \\ {i}_{q}\end{matrix} )$$
$$\frac{d σ}{d t} + λ σ = d ( t ) - ρ tan h ( K σ )$$
where, v_{di} and v_{qi} are the modulation signals in the two-phase rotating coordinate system, v_{d} is a voltage component along a d-axis direction, v_{q} is a voltage component along a q-axis direction, la is a current component along the d-axis direction, i_{q} is a current component along the q-axis direction, ω is a grid voltage angular frequency, L_{f} is a filter inductance value, i_{dref} and i_{qref} are the reference currents in the two-phase rotating coordinate system; λ is a positive gain coefficient of the sliding mode control loop, σ is a switching gain coefficient of the sliding mode control method, ρ is a proportional gain coefficient of the sliding mode control method, K is a positive real stiffness coefficient gain, tan h(Kσ) is a hyperbolic sine value of a sliding surface multiplied by gain, and d(t) is external disturbance.

5. The control method for improving the transient stability area of the grid-connected inverter according to claim 4, wherein the system asymptotic stability equation is expressed as:
$$λ ( {σ}_{d}^{2} + {σ}_{q}^{2} ) + ρ ( {σ}_{d} tan h ( K σ ) + {σ}_{q} tan h ( K {σ}_{q} ) > ( {σ}_{d} {d}_{d} ( t ) + {σ}_{q} {d}_{q} ( t ) )$$
where, σ_{d}, σ_{q}, d_{d}(t), d_{q}(t) are components of σ and d(t) in the two-phase rotating coordinate system obtained by using park transformation, respectively, and tan h(Kσ_{q}) is a hyperbolic sine value of the sliding surface multiplied by the gain;
if the system asymptotic stability equation holds true, the system is transiently stable, and if the system asymptotic stability equation does not hold, the system is transiently unstable;
wherein the grid-connected control comprises converting the modulation signals v_{di} and v_{qi} in the two-phase rotating coordinate system into three-phase PWM modulation signal v_{abci} through using the inverse park coordinate transformation, and passing the three-phase voltage output by the inverter through the LCL filter to filter out high-order harmonics, to achieve grid-connected control of the three-phase voltage type grid-connected inverter.

6. The control method for improving the transient stability area of the grid-connected inverter according to claim 5, wherein the Lyapunov function based on the electromagnetic energy is expressed as:
$$W ( {t}_{f} ) = \frac{1}{2} {L}_{f} [ ( {i}_{d}^{{f}^{2}} + {i}_{d}^{{f}^{2}} ) - ( {i}_{d}^{{0}^{2}} + {i}_{d}^{{0}^{2}} ) ] + {\int }_{{t}_{0}}^{{t}_{f}} \frac{2}{3} [ P - {P}_{i} ] dt$$
where, Pᵢ is output power of the grid-connected inverter, W is electromagnetic energy at time t_{f}, i_{d}^{f} and i_{q}^{f} are respectively two-phase components of the three-phase output current at fault clearing time t_{f} after performing the park coordinate transformation, i_{d}⁰ and i_{q}⁰ are respectively two-phase components of the three-phase output current at fault start time t₀ after performing the park coordinate transformation, and t_{cr} is key fault clearing time of the system;
wherein the Lyapunov function is used to determine the transient stability of the grid-connected inverter based on the conditions of W(t_{f})≤W(t_{cr}).

7. The control method for improving the transient stability area of the grid-connected inverter according to claim 6, wherein the absorption domain is expressed as:
$$E = {‖ Δ i ‖}^{2} = ( Δ {i}_{d}^{2} + Δ {i}_{q}^{2} )$$
$$Δ {i}_{d} = ( {i}_{d}^{f} - {i}_{d}^{0} ) , Δ {i}_{q} = ( {i}_{q}^{f} - {i}_{q}^{0} )$$
where, Δi is a current vector in a dq coordinate system, Δi_{d} is a difference between a current d-axis component value at the fault clearing time and the current d-axis component value at the fault start time, Δi_{q} is a difference between a current q-axis component value at the fault clearing time and the current q-axis component value at the fault start time;
wherein determining the transient stability condition of the grid-connected inverter through the absorption domain is: E(t_{f})≤E(t_{cr}).

8. A system applying the control method for improving the transient stability area of the grid-connected inverter according to claim 1, comprising: a power control module, a current control module, and a protection module;
wherein the power control module calculates a difference between a reference reactive power Q_{ref} and an actual reactive power Q measured at a grid-connected point, calculates a difference between a reference active power P_{ref} and an actual active power P measured at the grid-connected point, and passes the differences to a PI controller therethrough to obtain reference currents i_{dref} and i_{qref} in a two-phase rotating coordinate system required by the current control module;
wherein the current control module uses a sliding mode current control method to generate a dq voltage signal according to a current command value, and obtains a PWM modulated voltage control signal through inverse park transformation to realize grid-connected control of the inverter;
wherein the protection module is used to monitor an operating status of the grid-connected inverter and take corresponding protective measures when a fault or abnormal situation occurs, so as to avoid equipment damage or causing instability in a power grid.

9. The system according to claim 8, wherein the park coordinate transformation is to use a park coordinate transformation method to convert the three-phase voltage v_{abc} of the grid-connected point of the inverter and the three-phase output current i_{abc} of the inverter into a three-phase voltage component v_{dq} of the grid connection point of the inverter of a dq-axis of a two-phase rotating coordinate system and a three-phase output current component i_{dq} of the inverter;
wherein the current command value comprises that referring to a difference between a reference reactive power Q_{ref} and an actual reactive power Q measured at the grid connection point and a difference between a reference active power P_{ref} and an actual active power P measured at the grid connection point and obtaining reference currents i_{dref} and i_{qref} at a two-phase rotating coordinate system required by the current control module by using a PI controller.

10. The system according to claim 9, wherein the dq voltage signal takes the three-phase voltage component v_{dq} of the grid-connected point of the inverter, the three-phase output current component i_{dq} of the inverter, and the reference currents i_{dref} and i_{qref} as inputs to the current control module, so as to output modulation signals v_{di} and v_{qi} in the two-phase rotating coordinate system.

11. The system according to claim 10, wherein the modulated signals v_{di} and v_{qi} in the two-phase rotating coordinate system are expressed as:
$$( \begin{matrix}{v}_{di} \\ {v}_{qi}\end{matrix} ) = ( \begin{matrix}{v}_{d} \\ {v}_{q}\end{matrix} ) - ( \begin{matrix}- {i}_{q} \\ {i}_{d}\end{matrix} ) ω {L}_{f} + {L}_{f} \frac{d}{dt} ( \begin{matrix}{i}_{dref} \\ {i}_{qref}\end{matrix} ) + {L}_{f} λ σ + {L}_{f} ρ tan h ( Kσ )$$
$$σ = ( \begin{matrix}{i}_{dref} \\ {i}_{qref}\end{matrix} ) - ( \begin{matrix}{i}_{d} \\ {i}_{q}\end{matrix} )$$
$$\frac{d σ}{d t} + λ σ = d ( t ) - ρ tan h ( K σ )$$
where, v_{di} and v_{qi} are the modulation signals in the two-phase rotating coordinate system, v_{d} is a voltage component along a d-axis direction, v_{q} is a voltage component along a q-axis direction, i_{d} is a current component along the d-axis direction, i_{q} is a current component along the q-axis direction, σ is a grid voltage angular frequency, L_{f} is a filter inductance value, i_{dref} and i_{qref} are the reference currents in the two-phase rotating coordinate system; λ is a positive gain coefficient of the sliding mode control loop, σ is a switching gain coefficient of the sliding mode control method, ρ is a proportional gain coefficient of the sliding mode control method, K is a positive real stiffness coefficient gain, tan h(Kσ) is a hyperbolic sine value of a sliding surface multiplied by gain, and d(t) is external disturbance.

12. The system according to claim 11, wherein the system asymptotic stability equation is expressed as:
$$λ ( {σ}_{d}^{2} + {σ}_{q}^{2} ) + ρ ( {σ}_{d} tan h ( K σ ) + {σ}_{q} tan h ( K {σ}_{q} ) > ( {σ}_{d} {d}_{d} ( t ) + {σ}_{q} {d}_{q} ( t ) )$$
where, σ_{d}, σ_{q}, d_{d}(t), d_{q}(t) are components of σ and d(t) in the two-phase rotating coordinate system obtained by using park transformation, respectively, and tan h(Kσg) is a hyperbolic sine value of the sliding surface multiplied by the gain;
if the system asymptotic stability equation holds true, the system is transiently stable, and if the system asymptotic stability equation does not hold, the system is transiently unstable;
wherein the grid-connected control comprises converting the modulation signals v_{di} and v_{qi} in the two-phase rotating coordinate system into three-phase PWM modulation signal v_{abci} through using the inverse park coordinate transformation, and passing the three-phase voltage output by the inverter through the LCL filter to filter out high-order harmonics, to achieve grid-connected control of the three-phase voltage type grid-connected inverter.

13. The system according to claim 12, wherein the Lyapunov function based on the electromagnetic energy is expressed as:
$$W ( {t}_{f} ) = \frac{1}{2} {L}_{f} [ ( {i}_{d}^{{f}^{2}} + {i}_{d}^{{f}^{2}} ) - ( {i}_{d}^{{0}^{2}} + {i}_{d}^{{0}^{2}} ) ] + {\int }_{{t}_{0}}^{{t}_{f}} \frac{2}{3} [ P - {P}_{i} ] dt$$
where, Pᵢ is output power of the grid-connected inverter, W is electromagnetic energy at time t_{f}, i_{d}^{f} and i_{q}^{f} are respectively two-phase components of the three-phase output current at fault clearing time t_{f} after performing the park coordinate transformation, i_{d}⁰ and i_{q}⁰ are respectively two-phase components of the three-phase output current at fault start time t₀ after performing the park coordinate transformation, and t_{cr} is key fault clearing time of the system;
wherein the Lyapunov function is used to determine the transient stability of the grid-connected inverter based on the conditions of W(t_{f})≤W(t_{cr}).

14. The system according to claim 13, wherein the absorption domain is expressed as:
$$E = {‖ Δ i ‖}^{2} = ( Δ {i}_{d}^{2} + Δ {i}_{q}^{2} )$$
$$Δ {i}_{d} = ( {i}_{d}^{f} - {i}_{d}^{0} ) , Δ {i}_{q} = ( {i}_{q}^{f} - {i}_{q}^{0} )$$
where, Δi is a current vector in a dq coordinate system, Δi_{d} is a difference between a current d-axis component value at the fault clearing time and the current d-axis component value at the fault start time, Δi_{q} is a difference between a current q-axis component value at the fault clearing time and the current q-axis component value at the fault start time;
wherein determining the transient stability condition of the grid-connected inverter through the absorption domain is: E(t_{f})≤E(ter).
